(19) United States
(12) Patent Application Publication
(10) Pub. No.: US 2011/0216029 A1
(43) Pub. Date: Sep. 8, 2011

(54) SHEET WITH REFORMED LAYER AND MANUFACTURING METHOD THEREOF

(75) Inventors: Jingchun Jin, Saitama (JP); Kanami Yamazaki, Saitama (JP); Masato Saito, Saitama (JP)

(73) Assignee: KIMOTO CO., LTD, TOKYO (JP)

(21) Appl. No.: 13/129,142

(22) PCT Filed: Nov. 25, 2009
(86) PCT No.: PCT/JP2009/069871

§ 371 Date: May 13, 2011

(30) Foreign Application Priority Data
Nov. 28, 2008 (JP) 2008-304921

(51) Int. Cl. G06F 3/041; B32B 3/00; B32B 9/04; B32B 7/12; G21G 5/00

(52) U.S. Cl. 345/173; 428/220; 428/411.1; 428/343; 250/492.1

(57) ABSTRACT

Provided is a simple method for preventing oligomer deposition onto a film surface. Oligomer deposition onto the surface of a film substrate 11 is prevented by irradiating the film substrate 11 with ultraviolet light at an exposure dosage of 1500 mJ/cm² or larger, modifying at least a part of the film substrate 11, and forming a reformed layer 12.

### TECHNICAL FIELD

The present invention relates to a sheet with reformed layer and a manufacturing method thereof.

### BACKGROUND ART

Polyester films are widely used for a variety of optical use, such as a base film for a prism sheet of an LCD member, lens sheet, diffusion plate, reflective plate and touch panel, etc. and a base film for antireflection use and explosion proof use, etc. To obtain bright and clear images in these optical use, a base film to be used as an optical film is, due to the types of use, required to have preferable transparency and not to have any fault like foreign objects or scars, etc. that affects the images.

In recent years, however, as the use purposes have become diversified, processing condition and use condition of the films have become diversified and there has been a problem arisen, when performing a thermal treatment on a polyester film, that a polymer called oligomer (cyclic trimer) as a noncrosslinked component of the film is deposited on the film surface. When oligomer deposition onto the film surface is intense, it leads to various problems such that the oligomer adheres and contaminates during film processing and it becomes impossible to use it for the purpose requiring high transparency.

Conventionally, there have been a variety of proposals made as a method of preventing oligomer deposition onto the film surface. For example, the patent article 1 discloses a technique of forming a movable electrode, via a transparent astringent resin layer, on a lower surface of a movable electrode film having a hard coat layer formed on its upper surface, which is arranged to face to a fixed electrode supporter in a resistive film type transparent touch panel.

### PRIOR ART REFERENCE

### Patent Document

Patent document 1: Japanese Patent Unexamined Publication (KOKAI) No. 7-13695

### SUMMARY OF THE INVENTION

### Object to be Achieved by the Invention

In the above conventional method, by forming a transparent astringent resin layer on the lower surface of the movable electrode film, it is possible to prevent deterioration of the appearance and visibility caused by deposition of oligomer as a noncrosslinked component of the movable electrode film onto the movable electrode side resulting in a whitening state and a loss of transparency. Since the hard coat layer is formed on the upper surface of the movable electrode film, this hard coat layer prevents oligomer from depositing on the upper surface side of the movable electrode film from inside the movable electrode film.

However, in the conventional method above, it is necessary to blend a predetermined paint, apply the result to a lower surface of a movable electrode film, dry and, if necessary, cure by irradiating ultraviolet light, etc. to form an astringent resin layer. Therefore, there is concern about an increase of the steps and a decline of the productivity. Accordingly, there is a demand for a development of a technique which can improve the productivity.

An object of the present invention is to provide a manufacturing method of a sheet with a reformed layer, which can prevent oligomer deposition onto the film surface with a simple method, and a sheet with a reformed layer formed by this method. Another object is to provide a multilayer body comprising this sheet and a touch panel comprising this multilayer body.

### Means for Achieving the Object

The present invention attains the objects above by the following means. Note that reference numbers corresponding to drawings illustrating an embodiment of the present invention are added in the explanation below, however, the reference numbers are for easier understanding of the invention and not to limit the invention.

A manufacturing method of a sheet (10) according to the invention is for manufacturing a sheet with a reformed layer (12) formed by modifying at least a part of a film substrate (11), comprising the step of irradiating ultraviolet light to the film substrate (11) to form the reformed layer (12).

In the above invention, the ultraviolet light may be irradiated at an exposure dosage of 1500 mJ/cm² or larger.

In the above invention, the ultraviolet light may be irradiated several times separately.

In the above invention, a light having a light emission wavelength region of 200 to 450 nm and characteristics that a peak output comes at 360 to 370 nm may be used as the ultraviolet light.

In the above invention, a light having a light emission wavelength region of 200 to 450 nm and characteristics that a peak output comes at 360 to 370 nm and 250 to 320 nm may be used as the ultraviolet light.

In the above invention, a transparent polyester film may be used as the film substrate (11). Namely, as a result that a reformed layer (12) is formed by irradiating ultraviolet light on the film substrate (11) and modifying at least a part of the film substrate (11), oligomer deposition onto a surface of the film substrate (11) can be prevented.

A sheet (10) according to the invention has a reformed layer (12) formed by modifying at least apart of a film substrate (11), and the reformed layer (12) is formed by irradiating ultraviolet light to the film substrate (11).

In the above invention, the reformed layer (12) may have Martens hardness of 200 N/mm² or higher, an indentation elasticity modulus of 4300 MPa or lower, and a thickness of 0.1 μm or thicker.

In the above invention, values of the Martens hardness and the indentation elasiticity modulus may be measured under the condition that a maximum test load is 1 mN.

A multilayer body (20) according to the invention comprises functional layers (22 and 24) having various functions on a surface of any one of the sheets (10) mentioned above.

In the above invention, the functional layers (22 and 24) may comprise an adhesive layer stacked on the reformed layer (12) side of the sheet (10) and a hard coat layer stacked on the opposite side of the reformed layer (12) of the sheet (10).

A touch panel (5) according to the invention comprises a first electrode substrate (52) wherein a first transparent conductive film (524) is formed on a first transparent substrate (522), and a second electrode substrate (54) wherein a second transparent conductive film (544) is formed on a second transparent substrate (542) so as to face to the first transparent conductive film (524) by leaving a predetermined space. Also, a movable side electrode substrate of either one of the first transparent substrate (522) or the second transparent substrate (542) comprises the multilayer body (20).

### Effect of the Invention

According to the above invention, a reformed layer is formed by modifying at least a part of a film substrate as a result of irradiating ultraviolet light to the film substrate. The formed reformed layer prevents oligomer deposition from inside the film substrate. Namely, according to the above explained invention, there is no element of declining the productivity, such as separate blending of paint, applying of the same and other steps, comparing with the conventional methods, and oligomer deposition onto the film surface can be prevented with a simple method.

### BRIEF DESCRIPTION OF DRAWINGS

FIG. 1 is a sectional view showing a sheet according to an embodiment of the present invention.

FIG. 2 is a sectional view showing an example of a multilayer body having the sheet in FIG. 1.

FIG. 3 is a sectional view showing another example of a multilayer body having the sheet in FIG. 1.

FIG. 4 is a sectional view showing a touch panel having the multilayer body in FIG. 2.

FIG. 5 is a SEM image of a-section of a film before ultraviolet light irradiation.

FIG. 6 is a SEM image of a-section of the film after ultraviolet irradiation (1 pass).

FIG. 7 is a SEM image of a-section of the film after ultraviolet irradiation (2 passes).

FIG. 8 is a SEM image of a-section of the film after ultraviolet irradiation (3 passes).

FIG. 9 is a SEM image of a-section of the film after ultraviolet irradiation (10 passes).

FIG. 10 is a SEM image of a-section of the film after ultraviolet irradiation (20 passes).

FIG. 11 is a SEM image of b-section of the film before ultraviolet irradiation.

FIG. 12 is a SEM image of b-section of the film after ultraviolet irradiation (3 passes).

### MODE FOR CARRYING OUT THE INVENTION

Below, an embodiment of the present invention will be explained based on the drawings.

<Sheet>

As shown in FIG. 1, a sheet 10 according to the present embodiment comprises a film substrate 11, such as a transparent polyester film. In the present embodiment, at least a part of a surface of the film substrate 11 is modified, where a reformed layer 12 is formed. This reformed layer 12 is responsible for a function of preventing oligomer deposition onto the film substrate 11 surface from inside of the film substrate 11 in the present embodiment.

First, surface hardness is properly adjusted in the reformed layer 12 of the present embodiment. Specifically, Martens hardness (HM) is adjusted to be higher than a specific value, and an indentation elasticity modulus (EIT) is adjusted to be lower than a specific value.

The Martens hardness (HM) indicates hardness (how hard it is to be dented) of the reformed layer 12 obtained from a test load and an indentation surface area when indenting the surface of the reformed layer 12 with a Vickers indentor and is an index of hardness of the surface of the reformed layer 12. In the present embodiment, the HM value of the reformed layer 12 is adjusted preferably to be 200 N/mm² or larger, and more preferably 210 N/mm² or larger, although it varies depending on a material of the film substrate. The present inventors found that, by adjusting the HM of the reformed layer 12 to a predetermined value or larger, it became hard to be damaged and oligomer deposition to the outside from inside of the film substrate 11 could be effectively prevented. On the other hand, when considering flatness of the sheet 10 affected by deterioration of the film substrate 11, the HM of the reformed layer 12 is adjusted preferably to 350 N/mm² or smaller, and more preferably 300 N/mm² or smaller.

Note that the HM value in the present embodiment is obtained by measuring hardness of a surface of the reformed layer 12 by the method conform to ISO-14577-1 by using an ultramicro hardness testing machine (Fischer Instruments K. K., product name: FISCHERSCOPE HM2000) in an atmosphere at a temperature of 20° C. and relative humidity of 60%. Note that the value is measured at a maximum test load of 1 mN.

An indentation elasticity modulus (EIT) corresponds to a Young' s modulus, which indicates how easily the reformed layer 12 is bent (flexibility), and is an index of brittleness of the reformed layer 12. In the present embodiment, the EIT of the reformed layer 12 is adjusted to preferably 4300 MPa or lower, more preferably 4200 MPa or lower, and furthermore preferably 4100 MPa or lower. By adjusting the EIT of the reformed layer 12 to a predetermined value or smaller, it is possible to obtain a sheet 10 having excellent flexibility, on which a crack, etc. is not caused even when it is bent. On the other hand, when the EIT of the reformed layer 12 is too low, it becomes difficult to achieve a good balance with the HM in an appropriate range explained above, in addition, the property of preventing oligomer deposition tends to decline. Therefore, the EIT of the reformed layer 12 is adjusted preferably to 3400 MPa or higher, and more preferably 3500 MPa or higher.

Note that the value of the EIT is a value corresponding to a Young's modulus measured conform to ISO-14577-1 by using the same machine as that in the case of HM explained above, and it is a Young's modulus of the reformed layer 12 itself calculated by measuring recoverability of an indentation (elasticity modulus) when indenting the reformed layer 12 with an indentor. Note that it is a value measured with a maximum test load of 1 mN, same as in the case of the HM.

Second, a thickness (t) of the reformed layer 12 is adjusted appropriately in the present embodiment. Specifically, the thickness (t) is preferably 0.1 μm or thicker, and more preferably 0.2 μm or thicker. It is because when the thickness is too thin, the effect of preventing oligomer deposition cannot be fully brought out. On the other hand, when the thickness is too thick, flatness of the sheet 10 may be diminished in some cases. Therefore, the thickness (t) of the reformed layer 12 is preferably 1.5 μm or thinner, and more preferably 1.2 μm or thinner.

A value of a flex resistance test (crack resistance 1) of the sheet 10 is preferably adjusted to 2 mm or smaller, although it varies depending on the thickness (t) of the reformed layer 12 and a kind and thickness of the film substrate 11. When the value of the flex resistance test is adjusted to a predetermined value, crack resistance of the reformed layer 12 can be improved. Note that the value of the flex resistance test is measured by the cylindrical mandrel method conform to JIS-K5600-5-1(1999).

Although a state of the bend test (crack resistance 2) of the sheet 10 varies depending on the thickness of the reformed layer 12 and a kind and thickness of the film substrate 11, it is preferable to have flexibility to a degree of not causing any cracks at a bent part when bending to double the sheet 10 at a random part so that the reformed layer 12 comes the outer side.

<Manufacturing Method of Sheet>

A reformed layer 12 of the present embodiment can be formed by irradiating a predetermined exposure dosage of ionizing radiation to a surface of a film substrate 11 and modifying at least apart of the film substrate 11 surface. Below, the case of using ultraviolet light as the ionizing radiation will be taken for explaining an example of a manufacturing method of a sheet 10.

First, a film substrate 11 is prepared. As the film substrate 11, for example, a transparent polyester film, etc. is used. The film substrate 11 may be subjected to an adhesion facilitating treatment on its surface. A thickness of the film substrate 11 is not particularly limited.

Next, the prepared film substrate 11 is irradiated with ultraviolet light. When using a film substrate 11 with an adhesion facilitating treatment on its surface, the surface to be irradiated with the ultraviolet light may be either the surface with the adhesion facilitating treatment or the surface with no adhesion facilitating treatment.

The present inventors found that, by irradiating a predetermined exposure dosage or larger ultraviolet light on the film substrate 11, at least a part of the ultraviolet light irradiated portion of the film substrate 11 surface modifies and, as a result, a reformed layer 12 to prevent oligomer deposition from inside the film substrate 11 to the outside can be formed as a separate layer from the film substrate 11.

Note that, in the present embodiment, “oligomer” is defined as those mainly comprising trimer component of polymer composing the film substrate 11 among low molecular weight substances crystallized and deposited on the film substrate 11 surface after a thermal treatment. “To prevent oligomer deposition” means, after performing a thermal treatment at a temperature of 150° C. for 1 hour on the film substrate 11, when observing the surface with the reformed layer 12 formed thereon of the film substrate 11 with a microscope at 200-fold magnification, there are less than 50 deposits having an equivalent circle diameter of 2 μm or larger per 10 visual fields (area of 0.5 mm²), preferably 20 or less, and furthermore preferably 10 or less.

To irradiate ultraviolet light, an ultraviolet lamp is used to generate ultraviolet light having a light emission wavelength region of, for example, 100 to 500 nm, and preferably 200 to 450 nm and to irradiated at a predetermined exposure dosage. As the ultraviolet lamp, for example, an ultra-high pressure mercury lamp, high pressure mercury lamp, low pressure mercury lamp, electrodeless lamp, carbon arc, xenon arc and metal halide lamp, etc. may be mentioned.

In the present embodiment, it is preferable to use an ultraviolet lamp having a light emission wavelength region in the range mentioned above, which generates the peak output (peak intensity) at least at 360 to 370 nm. Also, an ultraviolet lamp (for example, a high pressure mercury lamp and electrodeless lamp, etc.) having a light emission wavelength region in the range mentioned above, which further generates the peak output also at 250 to 320 nm in addition to 360 to 370 nm, may be used as well. Those having a peak, where the lamp output (w/10 nm) in the light emission wavelength region becomes maximum (maximum peak), at 360 to 370 nm are preferable, but those having the maximum peak at 250 to 320 nm may be also used. Peak to exist at 360 to 370 nm and 250 to 320 nm is not limited to one, and cases with two or more peaks are also included. By using light having its peak (including the maximum peak) in these specific wavelength regions, the effect of preventing oligomer deposition given to the reformed layer 12 to be formed is furthermore enhanced.

A cumulative exposure dosage of the ultraviolet light is, for example, 1500 mJ/cm² or larger, preferably 2000 mJ/cm² or larger, and more preferably 2500 mJ/cm² or larger in an exposure dosage. Note that when the exposure dosage to be irradiated is too large, the film substrate 11 is deteriorated and flatness of the sheet 10 is liable to be lost, therefore, it may be irradiated with an exposure dosage of preferably 30000 mJ/cm² or smaller, and more preferably 25000 mJ/cm² or smaller. It is not necessary to irradiate this amount at a time, and it is possible to irradiate a smaller exposure dosage a plurality of times separately. By irradiating a predetermined exposure dosage a plurality of times separately, damages on the film substrate 11 can be decreased even if the cumulative exposure dosage is same comparing with that in the case of irradiating a large exposure dosage at a time.

Note that, in the present embodiment, irradiation of the ultraviolet light may be performed only on one surface of the film substrate 11 or on both surfaces. When irradiating the ultraviolet light on both surfaces of the film substrate 11, the exposure dosage of irradiation may be changed on each surface.

In the present embodiment, ultraviolet light of a predetermined exposure dosage or larger is irradiated to the film substrate 11. Thereby, at least a part of the ultraviolet light irradiated portion on the film substrate 11 is modified, on which a reformed layer 12 is formed. The formed reformed layer 12 has appropriate surface hardness and thickness as explained above, therefore, oligomer deposition from inside the film substrate 11 onto the surface of the film substrate 11 is effectively prevented. Therefore, according to the present embodiment, oligomer deposition onto the film substrate 11 surface can be prevented with a simple method comparing with the conventional method including the elements of declining the productivity, such as separate blending of paint, applying and other steps.

Also, since the reformed layer 12 has appropriately adjusted surface hardness and thickness (t), it even satisfies various properties, such as crack resistance, blocking resistance, solvent resistance and improved wettability.

<Multilayer Body>

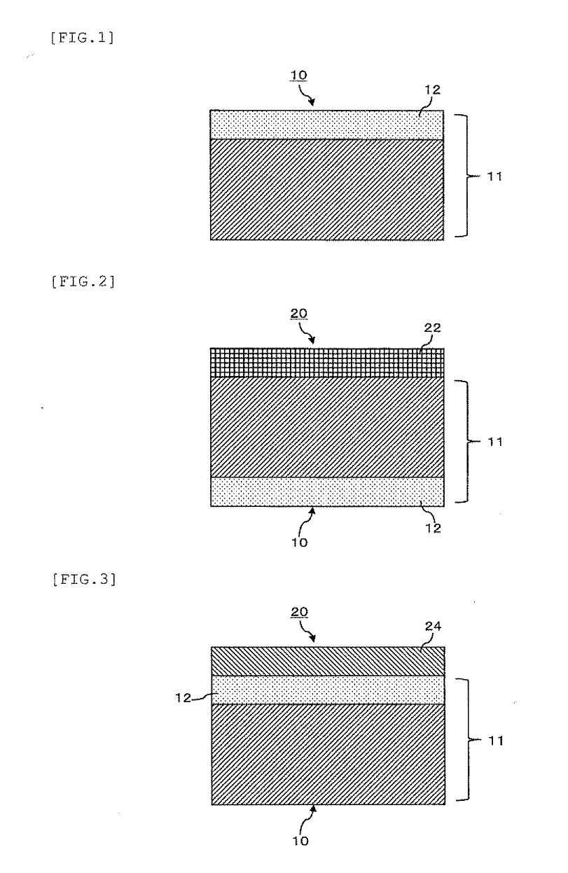

Both of multilayer bodies 20 shown in FIG. 2 and FIG. 3 comprise the sheet 10 shown in FIG, 1 explained above. Below, the case where the film substrate 11 has the reformed layer 12 only on one surface will be explained as an example.

As shown in FIG. 2, in the first aspect of the present embodiment, a first functional layer 22 given with a variety of functions is stacked on the opposite side of the reformed layer 12 of the sheet 10. As the first functional layer 22, for example, a hard coat layer, antireflection layer and other single layer films or multilayer films may be mentioned.

As shown in FIG. 3, in the second aspect of the present embodiment, a second functional layer 24, such as an adhesive layer explained above and a transparent conductive layer, is formed on the reformed layer 12 surface of the sheet 10. In this case, the first functional layer 22 shown in FIG. 2 may be furthermore stacked on the opposite side of the reformed layer 12 of the sheet 10.

<Hard Coat Layer>

A hard coat layer is provided to increase surface hardness of the multilayer body 20 and to prevent scratches on the surface. Therefore, when using a hard coat layer as the first functional layer 22, surface hardness of the hard coat layer is preferably H or higher, more preferably 2 H or higher, and furthermore preferably 3 H or higher. A value of the surface hardness is indicated by a pencil scratch value (pencil hardness) measured by a method conform to JIS-K5400 (1990).

The hard coat layer is composed of a resin, such as a thermoplastic resin, thermosetting resin, ionizing-radiation curable resin. Particularly, when composed of an ionizing-radiation curable resin, the hard coat property represented by surface hardness, etc. can be brought out, so that it is preferable.

As thermoplastic resin and thermosetting resins, for example, polyester resins, acrylic resins, acrylic urethane resins, polyester acrylate resins, polyurethane acrylate resins, epoxy acrylate resins, urethane resins, epoxy resins, polycarbonate resins, cellulose resins, acetal resins, polyethylene resins, polystyrene resins, polyamide resins, polyimide resins, melamine resins, phenol resins and silicone resins, etc. may be mentioned.

As ionizing-radiation curable resins, photopolymerizable prepolymers, which crosslink and cure by being irradiated with ionizing radiation (ultraviolet light or electron beam), may be used. In this embodiment, later explained photopolymerizable prepolymers may be used alone or used in combination of two or more kinds.

Photopolymerizable prepolymers are divided to a cationic polymerization type and a radical polymerization type.

As cationic polymerization type photopolymerizable prepolymers, epoxy resins, vinyl ether resins, etc. may be mentioned. As epoxy resins, for example, bisphenol epoxy resins, novolac epoxy resins, alicyclic epoxy resins and alifatic epoxy resins, etc. may be mentioned.

As radical polymerization type photopolymerizable prepolymers, acrylic prepolymers (hard prepolymers), which have two or more acryloyl groups in one molecule and become to have a three-dimensional net-like structure when crosslinked and cured, are particularly preferably used in terms of the hard coat property.

As acrylic prepolymers, urethane acrylate, polyester acrylate, epoxy acrylate, melamine acrylate, polyfluoroalxyl acrylate and silicone acrylate, etc. may be mentioned.

Urethane acrylate prepolymers can be obtained, for example, by performing esterification with a reaction with (meth)acrylic acid on polyurethane oligomer obtained by a reaction between polyether polyol or polyester polyol and poly isocyanato. Polyester acrylate prepolymers can be obtained, for example, by performing esterification with (meth)acrylic acid on hydroxyl group of polyester oligomer having hydroxyl group at both ends obtained by condensate of polyhydric carboxylic acid and polyhydric alcohol, or obtained by performing esterification with (meth)acrylic acid on hydroxyl group at ends of oligomer obtained by adding alkylene oxide to polyhydric carboxylic acid. Epoxyacrylate prepolymers can be obtained, for example, by performing esterification with a reaction between (meth)acrylic acid and oxirane ring of a relatively low molecular-weight bisphenol epoxy resin or novolac epoxy resin. Acrylic prepolymers may be used alone, however, it is preferable to add a photopolymerizable monomer in order to give a variety of functions of improving crosslinking curability and adjusting shrinkage due to curing, etc.

As photopolymerizable monomers, monofunctional acrylic monomers (for example, 2-ethylhexyl acrylate, 2-hydroxyethyl acrylate, 2-hyrdoxypropyl acrylate, butoxyethyl acrylate, etc.), bifunctional acryl monomers (for example, 1,6-hexanediol diacrylate, neopentyl glycol diacrylate, diethylene glycol diacrylate, polyethylene glycol diacrylate, hydroxyl pivalic acid ester neopentyl glycol diacrylate, etc.), tri- or more functional acrylic monomers (for example, dipentaerythritol hexacrylate, trimethylol propane triacrylate, pentaerythritol triacrylate, etc.) may be mentioned. Note that “acrylate” includes methacrylate in addition to acrylate in literal terms. These photo-polymerable monomers may be used alone or used in combination of two or more kinds.

In forming a hard coat layer, when it is cured by ultraviolet light irradiation for use, it is preferable to blend additives, such as a photopolymerization initiator, a photopolymerization accelerator and ultraviolet light sensitizer, in addition to photopolymerizable prepolymers and photopolymerizable monomers.

As photopolymerization initiators for radical polymerization type photopolymerizable prepolymers and photopolymerizable monomers, for example, acetophenone, benzophenone, Michiler's ketone, benzoin, benzylmethylketal, benzoyl benzoate, α-acyl oxime ester, thioxanthones, etc. may be mentioned. As photopolymerizable initiators for cationic polymerization type photopolymerizable prepolymers, for example, compounds consisting of aromatic sulfonium ion, aromatic oxosulfonium ion, aromatic iodonium ion and other oniums, and anions of tetrafluoroborate, hexafluorophosphate, hexafluoroantimonate, hexafluoroarcenate, etc. may be mentioned. These may be used alone or in combination of two or more kinds. As photopolymerization accelerators, p-dimethyl aminobenzoate isoamyl ester, p-dimethyl aminobenzoate ethylester, etc. may be mentioned. As ultraviolet sensitizers, n-butylamine, triethylamine and tri-n-butylphosphine, etc. may be mentioned.

A blending amount of these additives is normally selected from a range of 0.2 to 10 parts by weight with respect to 100 parts by weight of above-mentioned photopolymerizable prepolymers and photopolymerizable monomers in total.

The hard coat layer of the present embodiment may be properly blended with additive components, if necessary, as long as in a range of not hindering the effects of the present invention. As additive components, for example, surface stabilizers, lubricants, colorants, pigments, dyes, pluorescent whitening agents, flame retardants, antibacterial agents, antifungal agents, ultraviolet ray absorbents, light stabilizers, thermal stabilizers, antioxidants, plasticizers, leveling agents, fluidity control agents, defoaming agents, dispersants, storage stabilizers, crosslinking agents and silane coupling agents, etc. may be mentioned.

The hard coat layer has a thickness of preferably 0.1 to 30 μm or so, more preferably 0.5 to 15 μm, and furthermore preferably 2 to 10 μm. When the thickness is 0.1 μm or thicker, sufficient surface hardness (hard coat property) can be brought out also on the hard coat layer side.

<Antireflection Layer>

An antireflection layer is provided on a surface of the hard coat layer and is for decreasing reflection on the surface portion of the hard coat layer and improving the total light transmittivity of the whole multilayer body 20. To prevent reflection on the surface portion, it is also considered to design the refractive index of the hard coat layer to be small. However, when designing the hard coat layer to have a small refractive index, the hard coat property of the hard coat layer declines in some cases, so that it is preferable to form on the hard coat surface a thin antireflection layer having a lower refractive index than that of the hard coat layer.

The antireflection film may be composed of a material having a lower refractive index than that of the hard coat film and, for example, silicon-based resins, fluorine-based resins, metal oxide sol, and these materials added with metal oxide fine particles, preferably porous or hollow metal oxide fine particles to may be mentioned. Also, those resins listed in the paragraph explained on hard coat layer added with these metal oxide fine particles may be used, as well.

As metal oxide sol, silica and alumina sol, etc. may be mentioned. Among these metal oxide sol, silica sol is preferably used in terms of the refractive index, fluidity and the cost. Note that metal oxide sol indicates the materials, in which the Tyndall phenomenon cannot be observed due to an existence of metal oxides, that is, so-called homogenous solutions. For example, even materials generally referred to as colloidal silica sol, if the Tyndall phenomenon is observed, they are considered not included in the metal oxide sol in the present embodiment.

Metal oxide sal as such may be fabricated by hydrolyzing a metal alkoxide, such as tetraethoxysilane, methyltrimethoxysilane, zirconium propoxide, aluminum isopropoxide, titanium butoxide and titanium isopropoxide. As a solvent of metal oxide sol, methanol, ethanol, isopropanol, butanol, acetone, and 1,4-dioxane, etc. may be mentioned.

The metal oxide fine particle is fine particle of the metal oxides mentioned above and, for example, silica fine particle and alumina fine particle, etc. may be mentioned. Among them, silica fine particle is preferably used in terms of the refractive index, fluidity and cost. Also, a shape of the metal oxide fine particle is not particularly limited, but porous or hollow metal oxide fine particles having a low refractive index is preferably used.

As such a metal oxide fine particle, those having a certain particle diameter so that the Tyndall phenomenon is observed when made to be a dispersing solution are used. The average particle diameter of the metal oxide fine particle is not particularly limited as long as the above condition is satisfied, however, it is preferably in a range of 40 to 100 nm. When using fine particle having an average particle diameter of 40 nm or larger, there is no metal oxide particle floating on the surface of the antireflection layer and a decline of the surface hardness can be prevented. When using fine particle of 100 nm or smaller, the metal oxide fine particle does not spread out of the antireflection layer and a decline of the surface hardness can be prevented. Furthermore preferably, the average particle diameter of the metal oxide fine particle is in a range of 40 to 70 nm so as to obtain preferably transparency.

A mixing ratio of the metal oxide sol and metal oxide fine particle is not particularly limited, but the metal oxide fine particle is preferably 5 parts by weight or higher and more preferably 20 parts by weight or higher, and preferably 200 parts by weight or lower and more preferably 100 parts by weight or lower with respect to 100 parts by weight of metal oxide components in the metal oxide sol.

A thickness of the antireflection layer preferably satisfies the formula below from the theory of antireflection of light.

d=(a+1)λ/4n [Formula 1]

Here, “d” is a thickness of the antireflection layer (the unit is “nm”), “a” is 0 or positive even numbers, “λ” is central wavelength of reflection-prevented light, and “n” is a refraction index of the antireflection layer. Specifically, for example, about 2 μm or thinner is preferable, 1 μm or thinner is more preferable, 0.8 μm or thinner is furthermore preferable, 0.5 μm or thinner is particularly preferable, and 0.3 μm or thinner is most preferable. When the thickness of the antireflection layer becomes thick, uneven interference caused by uneven thickness is hard to arise, while the hard coat property of the hard coat layer provided on the lower surface is hard to be brought out.

A method of forming the hard coat layer and antireflection layer explained above is to blend respective components and other components in accordance with need, fabricate an application liquid by furthermore dissolving or dispersing in a proper solvent, successively apply the application liquid by a well-known method, such as a roll coating method, bar coating method, spray coating method, air knife coating method, dye coating method, blade coating method, spin coating method, gravure coating method, flow coating method and screen printing method, dry and, if necessary, cure with a required curing method properly.

<Adhesive Layer>

An adhesive layer may be composed of well-known adhesives, for example, elastomer adhesives, such as natural rubber based, reclaimed rubber based, chloroprene rubber based, nitrile rubber based and stylene butadiene based adhesives, and synthetic-resin adhesives, such as acrylic, polyester based, epoxy based, urethane based and cyano acrylate based adhesives, as well as emulsion based adhesives. The adhesive layer generally has a thickness of 5 μm or thicker to provide the adhesiveness. An adhesive layer as such can be manufactured by dissolving or dispersing in a solvent an adhesive component, crosslinking agent and other additives added in accordance with need to fabricate an application liquid for the adhesive layer, applying the same to the reformed layer 12 of the sheet 10 by the same conventionally well-known coating method as those mentioned in the antireflection layer explained above and drying. Also, it can be manufactured by applying the application liquid for an adhesive layer to a separator, etc., drying the same, then, laminating on the reformed layer 12 of the sheet 10.

The first functional layer 22 explained above may be also provided with an ultraviolet light absorbing property. Particularly, when setting a light transmittivity in a range of 350 to 380 nm to 0.1% to 70% or so, weather resistance can be given while keeping the hard coat property. When using an ionizing-radiation curable resin as the hard coat layer, the ultraviolet light absorbing property can be given without affecting curing of the hard coat layer by adjusting an ultraviolet light region for the ionizing-radiation curable resin to cure and an ultraviolet light region to be absorbed. For example, it is preferable to use a photopolymerization initiator having a peak of an absorbing wavelength region at a position different by at least 20 nm from a peak of an absorbing wavelength region of the ultraviolet light absorbent. As a result, the hard coat layer can be cured sufficiently, and an excellent hard coat property can be given.

<Transparent Conductive Layer>

A transparent conductive layer can be composed of, for example, generally widely-known transparent conductive materials and organic conductive materials, etc. As a transparent conductive material, for example, an indium oxide, tin oxide, indium tin oxide, gold, silver, palladium and other transparent conductive substances may be mentioned. As an organic conductive material, for example, polyparaphenylene, polyacetylene, polyaniline, polythiophene, polyparaphenylenevinylene, polypyrrole, polyfuran, polyselenophene, polypyridine and other conductive polymers may be mentioned. Among them, it is preferably composed of a transparent conductive material mainly containing any one of an indium oxide, tin oxide and indium tin oxide, which are excellent in transparency and conductivity and available at relatively low costs.

The transparent conductive layer can be formed to be in a thin film state by using the conductive materials listed above by a dry process (for example, a vacuum deposition method, sputtering method and ion plating method, etc.) or a wet process (for example, a solution coating method, etc.).

A thickness of the transparent conductive layer varies depending on the material to be used, but it is a thickness by which a surface resistivity becomes 10000 or lower, and preferably 5000 or lower. For example, 10 nm or thicker is preferable, and 20 nm or thicker is furthermore preferable. When considering economic efficiency, a range of 80 nm or thinner, preferably 80 nm or thinner, is preferable. In a thin film as such, interference pattern of visible light caused by an uneven thickness of the transparent conductive layer is hard to arise. Also, the total light transmittivity is normally preferably 80% or higher, more preferably 85% or higher, and particularly preferably 88% or higher.

In the present embodiment, particularly, the multilayer body 20 having the configuration, that the first functional layer 22 obtained by stacking the transparent hard coat layer and the antireflection layer in order is formed on the opposite surface side of the reformed layer 12 of the sheet 10 and the second functional layer 24 composed of the transparent conductive layer is formed on the reformed layer 12 surface side, can be used as an electrode substrate of an antistatic film, infrared ray shielding film, antireflection film, electromagnetic wave shielding film and touch panel, etc.

Below, an explanation will be made on the case where the multilayer body 20, wherein the first functional layer 22 obtained by stacking the transparent hard coat layer and antireflection layer in order is formed on the opposite surface side of the reformed layer 12 of the sheet 10 and the second functional layer 24 composed of the transparent conductive layer is formed on the reformed layer 12 surface side, is used as a touch panel.

<Touch Panel>

A touch panel 5 shown in FIG. 4 is a resistive film type touch panel mounted on the front side of a display element 9, such as a liquid crystal, provided to a variety of electronic devices (for example, a mobile phone and car navigation system, etc.). By viewing or selecting and operating letters, signs and graphics, etc. displayed on the display element 9 behind through the touch panel 5 by pressing with a finger or special pen, etc., various functions of the device can be switched.

The touch panel 5 in the present embodiment comprises an upper electrode substrate (first electrode substrate) 52 and a lower electrode substrate (second electrode substrate) 54. The upper electrode substrate 52 has an upper transparent substrate (first transparent substrate) 522. On a lower surface of the upper transparent substrate 522, an upper transparent conductive film (first transparent conductive film) 524 is formed. The lower electrode substrate (second electrode substrate) 54 has a lower transparent substrate (second transparent substrate) 542. On an upper surface of the lower transparent substrate 542, a lower transparent conductive film (second transparent conductive film) 544 is formed.

On the touch panel 5, either one of the upper electrode substrate 52 side or the lower electrode substrate 54 side may be a movable electrode. In this embodiment, the case where the upper electrode substrate 52 is a movable electrode and the lower electrode substrate 54 is a fixed (unmovable) electrode will be taken as an example.

In this embodiment, both outer rim portions of the lower surface of the upper electrode substrate 52 and the upper surface of the lower electrode substrate 54 are put together via a spacer 56 having an approximately frame shape. Also, the upper transparent conductive film 524 of the upper electrode substrate 52 and the lower transparent conductive film 544 of the lower electrode substrate 54 are arranged to face to each other leaving a predetermined space. On the upper surface of the lower transparent conductive film 544, a plurality of spacers 58 in dot shapes are arranged at predetermined intervals when needed. Note that the spacers 58 may be arranged in accordance with need and the configuration may be without any spacers 58.

At both ends of the upper and lower transparent conductive films 524 and 544, a pair of electrodes (the illustration is omitted) are formed, respectively. In this embodiment, a pair of upper electrodes (not shown) formed on the upper transparent conductive film 524 and a pair of lower electrodes (not shown) formed on the lower transparent conductive film 544 are arranged in the mutually crossing directions.

Note that, in this embodiment, a separator (the illustration is omitted) may be adhered to the lower surface of the lower electrode substrate 54 via an adhesive layer 7.

To mount the touch panel 5 of the present embodiment on the front surface of the display element 9, such as a color liquid crystal, the separator (not shown) on the touch panel 5 is removed to expose the adhesive layer 7 and bring it face and contact with the front surface of the display element 9. Thereby, a color liquid crystal display element with a touch panel can be formed.

In this liquid crystal display element with a touch panel, when a user operates by pressing an upper surface of the upper electrode substrate 52 with a finger or pen, etc. while viewing a display on the display element 9 placed behind the touch panel 5, the upper electrode substrate 52 is bent so that the upper transparent conductive film 524 contacts with the lower transparent conductive film 544 at the pressed portion. As a result of electrically detecting this contact via the pairs of upper and lower electrodes explained above, the pressed position is detected.

In the present embodiment, the upper electrode substrate 52 being a movable electrode is composed of the multilayer body 20 explained above (configured by stacking in order from below to above, a second functional layer 24 (transparent conductive layer), reformed layer 12, film substrate 11, first functional layer 22 (transparent hard coat layer and antireflection layer)). The second functional layer 24 (transparent conductive layer) of the multilayer body 20 corresponds to the upper transparent conductive film 524.

In this embodiment, the lower transparent substrate 542 of the lower electrode substrate 54 being a fixed electrode is composed, for example, of glass, etc.

Note that, in addition to the movable electrode, the fixed electrode (the lower electrode substrate 54) may also adopt the above-explained multilayer body 20 in this embodiment. Thereby, a lighter, thinner and hard-to-break touch panel can be attained.

The embodiment explained above is described to facilitate understanding of the present invention and is not to limit the present invention. Accordingly, respective elements disclosed in the above embodiment include all design modifications and equivalents belonging to the technical scope of the present invention.

### EXAMPLES

Next, further specified examples of the above-explained embodiment of the invention will be given and explained in detail.

### Examples 1 to 6

First, as a film substrate 11, a PET film (U34 made by TORAY Industries, Inc., provided with a easy adhesive layer: Hereinafter, referred to as “a film a”.) having a thickness of 125 μm was prepared.

Next, the prepared film a was fed at a speed of 2 m/min. and the easy adhesive layer surface of the film a being fed was irradiated (irradiation exposure dosage=approximately 960 mJ/cm²) with ultraviolet light (light emitting wavelength region: 250 to 400 nm, peak wavelength: 360 to 370 nm (maximum), 250 to 260 nm and 300 to 320 nm) generated at an output of 120 W/cm² by using a high pressure mercury light for 6 seconds. This irradiation cycle was defined as “1 pass”, and irradiation of ultraviolet light was performed by the number of “passes” shown in Table 1, so that film samples were obtained.

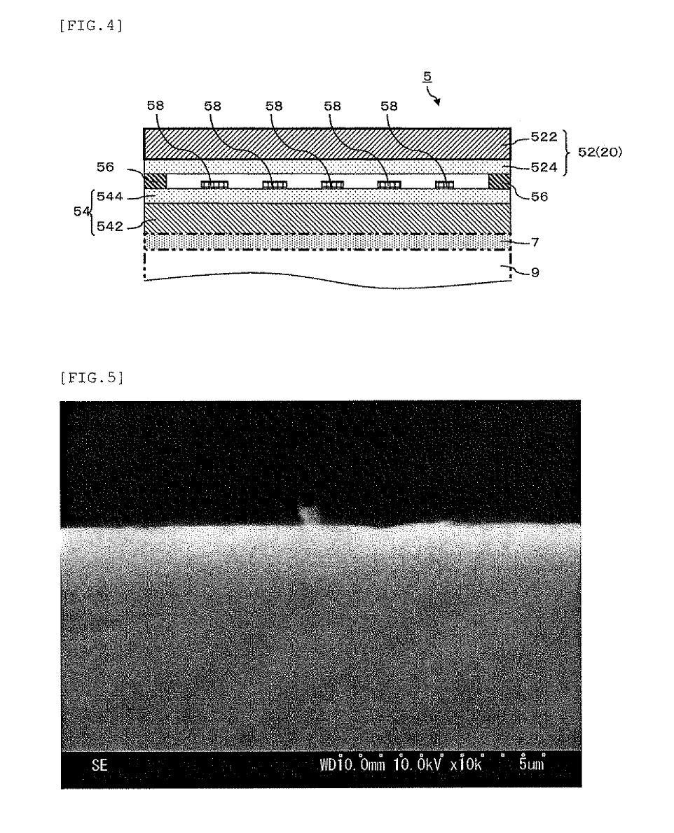

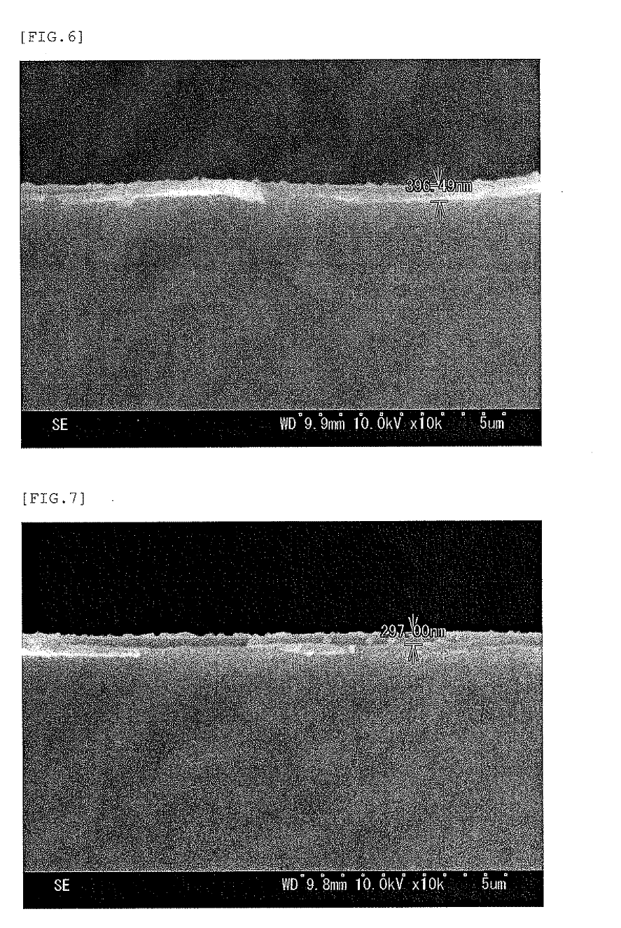

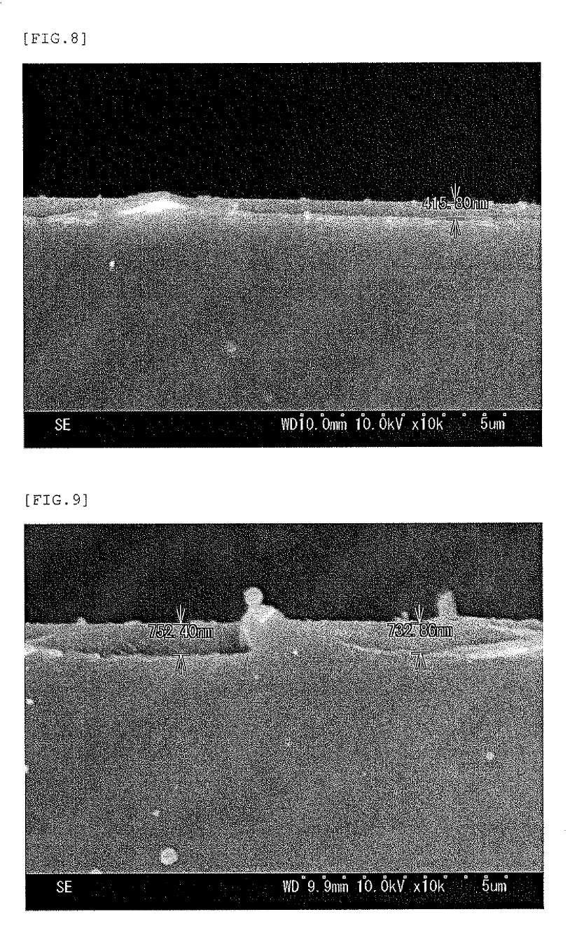

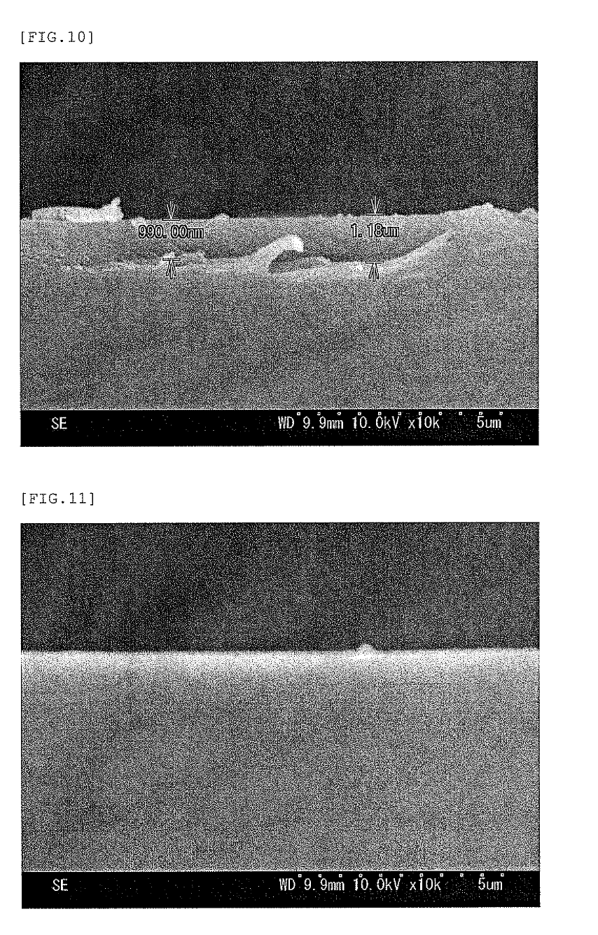

Gross sections of the obtained film samples were observed by using a SEM (Scanning Electron Microscope). SEM images taken before the ultraviolet irradiation (0 pass), after 1 pass, after 2 passes, after 3 passes, after 10 passes and after 20 passes are shown in FIG. 5 to FIG. 10. As shown in FIG. 6 to FIG. 10, it was confirmed that, when irradiated with ultraviolet light, a reformed layer was formed on the surface irradiated with the ultraviolet light of the film a. Note that, as shown in FIG. 5, a reformed layer was of course not formed on the film a before the irradiation of the ultraviolet light.

### Examples 7 to 12

Other than using a PET film (T-60 made by TORAY Industries, Inc. not provided with any easy adhesive layer: Hereinafter, referred to as “a film b”.) having a thickness of 100 μm as a film substrate 11, irradiation of ultraviolet light was performed under the same condition as that in the examples 1 to 6, and film samples were obtained.

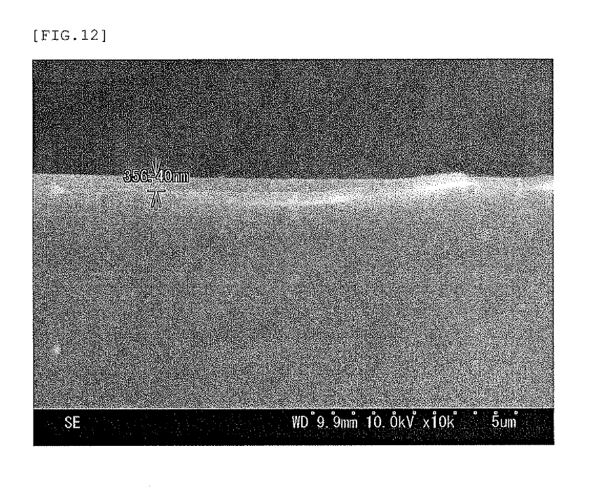

Cross sections of the obtained film samples were observed by using a SEM. SEM images taken before the ultraviolet irradiation (0 pass) and after 3 passes are shown in FIG. 11 and FIG. 12. As shown in FIG. 12, it was confirmed that, when irradiated with ultraviolet light, a reformed layer was formed on the ultraviolet light irradiated surface of the film b. Note that, as shown in FIG. 11, a reformed layer was of course not formed on the film b before the irradiation of the ultraviolet light.

### Examples 13 to 18

Other than using a PET film (A4300 made by TOYOBO Co., Ltd., provided with a easy adhesive layer: Hereinafter, referred to as “a film c”.) having a thickness of 125 μm as a film substrate 11, irradiation of ultraviolet light was performed under the same condition as that in the examples 1 to 6, and film samples were obtained.

<Evaluation of Characteristics>

The film samples obtained from the examples 1 to 18 above were evaluated as to the characteristics explained below. The results are shown in Table 1.

(1) Martens Hardness (HM) and Indentation Elasticity Modulus (EIT)

For both, an ultramicro hardness testing machine (Fischer Instruments K.K., product name: FISCHERSCOPE HM2000) was used to measure hardness and Young's modulus of the surface of the reformed layer formed on the obtained film samples (or of a film surface when the sample was not irradiated with the ultraviolet light) by the method conform to ISO-14577-1 under a measurement condition explained below. For both of HM and EIT, the measurement condition was: an indentor shape being a Vickers indentor (a=136°), measurement environment with a temperature at 20° C. and relative humidity of 60%, a maximum test load of 1 mN, a load rate at 1 mN/20 sec., a maximum load creep time of 5 sec., and unloading rate at 1 mN/20 sec.

(2) Heat Resistance (Oligomer Deposition Prevention Property, Microscope)

First, on the opposite side of the ultraviolet light irradiated surface of each obtained film sample, an ultraviolet light curable acrylic hard coat layer having a thickness of 6 μm was formed. Next, the film sample having the hard coat layer formed thereon was put in an oven at 150° C. and taken out after one hour. Next, the ultraviolet light irradiated surface (a film surface when the sample was not irradiated with the ultraviolet light) of the taken-out film sample was observed with a microscope (200-fold magnification). Those with 10 or less deposits having an equivalent circle diameter of 2 μm or larger per 10 visual fields (area of 0.5 mm²) were evaluated as “∘”, those having 20 or more but less than 50 of such deposits (considered no problem although oligomer deposition was observed to a certain degree) were evaluated “Δ”, and those having 50 or more of such deposits (oligomer deposition was observed) were evaluated “×”.

(3) Heat Resistance (Oligomer Deposition Prevention Property, Haze)

First, a hard coat layer was formed on each obtained film sample in the same way as in (2) above. Next, a haze value “%” (JTS-K7136: 2000) of the film sample having a hard coat layer formed thereon was measured by using a haze meter (NDH2000 made by NIPPON DENSHOKU INDUSTRIES Co., Ltd.). After that, the film sample finished with the haze value measurement was put in an oven at 150° C. and taken out after one hour in the same way as in (2) above. Then, a haze value of the taken-out film sample was measured in the same way as above.

(4) Crack Resistance

(4-1) Mandrel

Based on the flex resistance (cylindrical mandrel method) conform to JIS-K5600-5-1(1999), each film sample was wound around an iron stick having a diameter of 2mm so that the reformed layer faced the outside, and whether or not a crack arose on the wound portion of the reformed layer was visually observed. As a result, those with no cracks confirmed were evaluated as “∘” and those having cracks were evaluated as “×”.

(4-2) Bend

Each film sample was bent to double so that the reformed layer comes to the outer side, and whether or not a crack arose at the bent portion of the reformed layer was visually observed. As a result, those with no cracks confirmed were evaluated as “∘” and those having cracks were evaluated as “×”.

(5) Blocking Resistance

First, a hard coat layer was formed on each film sample in the same way as in (2) above. Next, on the hard coat layer surface of the film sample with a hard coat layer, an ultraviolet light irradiated surface of another film sample was overlaid. Then, the both film samples were sandwiched by glass plates, and a weight of approximately 2 kg was placed thereon and left for 24 hours in an atmosphere of 50° C. Next, after visually observing the overlaid surface to confirm Newton rings arising condition, the two were separated. As a result, those with no Newton rings arose before separation and easily separated without making any peeling noise when separating were evaluated as “∘”, those with Newton rings arose partially before separating and separated with a small peeling noise when separating were evaluated as “Δ”, and those with Newton rings allover the surface before separating and separated with a big peeling noise when separating were evaluated as “×”.

(6) Refractive Index Measurement

A refractive index at 633 nm at 25° C. was measured on the ultraviolet light irradiated surface of each film sample by using an automatic wavelength scanning type ellipsometer (M-150 made by JASCO Corporation).

(7) Solvent Resistance

First, a hard coat layer was formed on each film sample in the same way as in (2) above. Next, the ultraviolet light irradiated surface of the film sample having a hard coat layer formed thereon was rubbed to and from for thirty times with a cotton cloth impregnated with methyl ethyl ketone. Then, the ultraviolet light irradiated surface of the film sample was observed with a microscope in the same way as in (2) above. Those exhibited oligomer deposition of about the same degree as that in evaluation in (2) above were evaluated as “∘”, and those exhibited worse than the evaluation in (2) were evaluated as “×”. Note that those with 0 pass and 1 pass of the respective film substrates were not evaluated here as explained later on because their evaluation was “×” in (2) above.

(8) Heat and Humidity Resistance (Oligomer Deposition Prevention Property, Microscope)

First, a hard coat layer was formed in the same way as in (2) above on each of the film samples obtained in examples 13 to 18.

Next, an acrylic adhesive layer was provided to be a dried thickness of approximately 20 μm on an anti-blocking layer of a hard coat film (KB film GSAB made by KIMOTO Co., Ltd.) having the configuration, that a hard coat layer is formed on one surface of a polyester film and the anti-blocking layer is formed on the other surface of the polyester film. Then, the adhesive layer is adhered to a coating surface of each of the film samples from examples 13 to 18 having the hard coat layer formed thereon, and after leaving for two hours in an environment of 150° C., the samples were left in an environment of 60° C. and 95% RH (a constant temperature and constant humidity device) for 240 hours and taken out. Then, evaluation was made by observing from the hard coat film side with a microscope in the same way as in (2) above.

TABLE 1

| | | | | Reformed layer | | | | | |
|---|---|---|---|---|---|---|---|---|---|
| | | Ultraviolet Irradiation | | | | | Oligomer Deposition | | |
| | | | Cummulative | | | | Preventing Property | | |
| | | | Exposure | | | | | Haze (%) | |
| | Film | Number | Amount | Thickness | HM | EIT | | Before | After |
| Example | Substrate | of Pass | (mJ/cm²) | (μm) | (N/mm²) | (MPa) | | Heating | Heating |
| 1 | Film a | 0 | 0 | — | 184 | 3276 | X | 0.6 | 10.7 |
| 2 | (U34) | 1 | 960 | 0.4 | 191 | 3304 | X | 0.6 | 8.6 |
| 3 | | 2 | 1920 | 0.3 | 204 | 3415 | Δ | 0.7 | 0.8 |
| 4 | | 3 | 2780 | 0.4 | 216 | 3730 | ◯ | 0.9 | 0.9 |
| 5 | | 10 | 9600 | 0.7 | 244 | 3906 | ◯ | 0.9 | 0.9 |
| 6 | | 20 | 19200 | 1.2 | 248 | 3978 | ◯ | 0.9 | 0.9 |
| 7 | Film b | 0 | 0 | — | 231 | 3844 | X | 2.1 | 14.4 |
| 8 | (T-60) | 1 | 960 | — | 219 | 3682 | X | 2.2 | 9.4 |
| 9 | | 2 | 1920 | 0.4 | 220 | 3756 | Δ | 2.2 | 4.4 |
| 10 | | 3 | 2780 | — | 229 | 3863 | ◯ | 2.6 | 2.8 |
| 11 | | 10 | 9600 | — | 233 | 3935 | ◯ | 2.5 | 2.5 |
| 12 | | 20 | 19200 | — | 244 | 4071 | ◯ | 2.6 | 2.5 |
| 13 | Film c | 0 | 0 | — | 199 | 3421 | X | 0.9 | 9 |
| 14 | (A4300) | 1 | 960 | — | 202 | 3434 | X | 0.7 | 3.1 |
| 15 | | 2 | 1920 | — | 208 | 3534 | Δ | 0.7 | 0.9 |
| 16 | | 3 | 2780 | — | 225 | 3705 | ◯ | 0.8 | 0.9 |
| 17 | | 10 | 9600 | — | 232 | 3848 | ◯ | 0.9 | 0.9 |
| 18 | | 20 | 19200 | 1.0 | 252 | 4061 | ◯ | 0.9 | 0.9 |

| | | Reformed layer | | | | | |
|---|---|---|---|---|---|---|---|
| | | Crack | | | | | Heat and |
| | Film | Resistance | | Blocking | Refraction | Solvent | Humidity |
| Example | Substrate | Mandrel | Bend | Resistance | Index | Resistance | Resistance |
| 1 | Film a | — | — | X | 1.56 | — | — |
| 2 | (U34) | ◯ | ◯ | X | — | — | — |
| 3 | | ◯ | ◯ | X | — | ◯ | — |
| 4 | | ◯ | ◯ | Δ | — | ◯ | — |
| 5 | | ◯ | ◯ | ◯ | — | ◯ | — |
| 6 | | ◯ | ◯ | ◯ | 1.63 | ◯ | — |
| 7 | Film b | — | — | X | — | — | — |
| 8 | (T-60) | ◯ | ◯ | X | — | — | — |
| 9 | | ◯ | ◯ | X | — | ◯ | — |
| 10 | | ◯ | ◯ | Δ | 1.64 | ◯ | — |
| 11 | | ◯ | ◯ | ◯ | — | ◯ | — |
| 12 | | ◯ | ◯ | ◯ | 1.63 | ◯ | — |
| 13 | Film c | — | — | X | 1.61 | — | X |
| 14 | (A4300) | ◯ | ◯ | X | — | — | X |
| 15 | | ◯ | ◯ | X | — | ◯ | Δ |
| 16 | | ◯ | ◯ | Δ | — | ◯ | ◯ |
| 17 | | ◯ | ◯ | ◯ | — | ◯ | ◯ |
| 18 | | ◯ | ◯ | ◯ | 1.68 | ◯ | ◯ |

As shown in Table 1, in all cases of using any of the film substrates regardless of an existence of a easy adhesive layer, by performing at least I pass of ultraviolet light irradiation (examples 2 to 6, 8 to 12 and 14 to 18, FIG. 6 to FIG. 10 and FIG. 12), it was confirmed that a part of the film substrate surface was modified and a reformed layer was formed thereon comparing with the cases of not performing the ultraviolet irradiation (examples 1, 7 and 13, FIG. 5 and FIG. 11 ). When ultraviolet light was irradiated for 2 passes or more (an ultraviolet light cumulative exposure dosage of 1500 mJ/cm² or larger), the reformed layer formed by modifying a part of the film substrate surface was confirmed to exhibit improvements in a variety of properties, such as preventing oligomer deposition even in a high temperature environment.

Note that also in the case where an adhesive layer is provided over the reformed layer, when the ultraviolet light was irradiated for 2 passes or more, the effect of preventing oligomer deposition was confirmed even in a high temperature high humidity environment.

Note that those using as a film substrate 11 a PET film (A4350 made by TOYOBO Co., Ltd., provided with a easy adhesive layer) having a thickness of 125 μm, a PET film (0300E made by Mitsubishi Polyester Film Corporation, provided with a easy adhesive layer) having a thickness of 125 μm, and a PET film (OFW made by TEIJIN Ltd., provided with a easy adhesive layer) having a thickness of 125 μm were also confirmed to exhibit similar tendency when the ultraviolet light irradiation was performed in the same way as in the examples 1 to 18 explained above and evaluated in the same way.

Also, when using electrodless lamps A to D as an ultraviolet light irradiation source instead of a high pressure mercury lamp, performing the ultraviolet light irradiation under the same condition as that in the examples 1 to 18 above, and evaluating in the same way, it was confirmed that the similar tendency was exhibited as that in the case of using a high pressure mercury lamp.

Ultraviolet light generated by using the respective lamps were as below. Lamp A: a light emission wavelength region of 220 to 440 nm, peak wavelength at 360 to 370 nm (maximum), 250 to 270 nm and 310 to 320 nm. Lamp B: a light emission wavelength region of 200 to 440 nm, peak wavelength of 360 to 370 nm (maximum), 250 to 260 nm and 310 to 320 nm. Lamp C: a light emission wavelength region of 250 to 450 nm, peak wavelength of 350 to 390 nm (maximum) and 390 to 450 nm. Lamp D: a light emission wavelength region of 250 to 450 nm, peak wavelength of 360 to 370 nm (maximum) and 400 to 410 nm (maximum).

### Example 19

First, on the opposite surface of the ultraviolet light irradiated surface of each of the obtained film samples in the example 4 (irradiated with the ultraviolet light for 3 passes), an ultraviolet light curable acrylic hard coat layer having a thickness of 6 μm was formed. Next, on the hard coat layer, an antireflection layer (refractive index of 1.36) having a thickness of approximately 0.1 μm was formed so as to attain the minimum reflectance around a wavelength of 550 nm. Then, on the ultraviolet irradiated surface of the film sample, an ITO film having a thickness of approximately 20 nm was formed by the sputtering method.

The upper electrode substrate 52 shown in FIG. 4 was composed of thus obtained first multilayer sample.

Next, a second multilayer body sample as the lower electrode substrate 54 shown in FIG. 4 was manufactured by forming an ITO film having a thickness of approximately 20 nm by the sputtering method on one surface of a hardened glass plate having a thickness of 1 mm, then, cutting the result to a 4-inch size (a rectangular shape of 87.3 mm×64.0 mm).

Next, on the surface having the ITO film of the second multilayer body sample, an ionizing-radiation curable resin (Dot Cure TR5903 made by TAIYO INK MFG. Co., Ltd.) as a spacer application liquid was printed in dot shapes by the screen printing method, then, ultraviolet light was irradiated by a high pressure mercury lamp so as to obtain spacers 58 having a 50 μm diameter and 8 μm height arranged at 1 mm intervals.

Next, the first multilayer body sample and the second multilayer body sample having the spacers 58 arranged thereon, were placed so that the ITO films of the both samples face to each other over a predetermined gap, and edges thereof were adhered with a 3 mm-width double-sided tape having a thickness of 30 μm, so that a touch panel sample corresponding to the touch panel 5 shown in FIG. 4 was manufactured. Note that, in this example, the adhesive portions of the both samples were designed to be out of a display surface region of the touch panel sample.

In the manufactured touch panel sample, it was confirmed that interference unevenness was hard to spot, consequently, it can be operated preferably.

### DESCRIPTION OF NUMERICAL NOTATIONS

10 . . . sheet, 11 . . . film substrate, 12 . . . reformed layer, 20 . . . multilayer body, 22 . . . first functional layer (functional layer), 24 . . . second functional layer (functional layer), 5 . . . touch panel, 52 . . . upper electrode substrate (first electrode substrate), 522 . . . upper transparent substrate (first transparent substrate), 524 . . . upper transparent conductive film (first transparent conductive film), 54 . . . lower electrode substrate (second electrode substrate), 542 . . . lower transparent substrate (second transparent substrate), 544 . . . lower transparent conductive film (second transparent conductive film), 56 and 58 . . . spacer, 7 . . . adhesive layer, 9 . . . display element

1. A manufacturing method of a sheet with a reformed layer formed by modifying at least a part of a film substrate, comprising the step of irradiating ultraviolet light to the film substrate to form the reformed layer.

2. The manufacturing method of a sheet according to claim 1, wherein:
the ultraviolet light is irradiated at an exposure dosage of 1500 mJ/cm² or larger.

3. The manufacturing method of a sheet according to claim 2, wherein:
the ultraviolet light is irradiated several times separately.

4. The manufacturing method of a sheet according to claim 1, wherein:
light having a light emission wavelength region of 200 to 450 nm and characteristics that a peak output comes at 360 to 370 nm is used as the ultraviolet light.

5. The manufacturing method of a sheet according to claim 4, wherein:
the ultraviolet light has characteristics that a peak output comes further at 250 to 320 nm.

6. The manufacturing method of a sheet according to claim 1, wherein:
a transparent polyester film is used as the film substrate.

7. A method of preventing oligomer deposition onto a film substrate surface, comprising the steps of irradiating ultraviolet light to the film substrate and modifying at least a part of the film substrate to form a reformed layer.

8. A sheet with a reformed layer formed by modifying at least a part of a film substrate, wherein the reformed layer is formed by irradiating ultraviolet light to the film substrate.

9. The sheet according to claim 8, wherein:
the reformed layer has Martens hardness of 200 N/mm² or higher, an indentation elasticity modulus of 4300 MPa or lower, and a thickness of 0.1 μm or thicker.

10. The sheet according to claim 8, wherein:
values of the Martens hardness and the indentation elasticity modulus are measured under the condition that a maximum test load is 1 mN.

11. A multilayer body, comprising a functional layer on a surface of the sheet according to claim 8.

12. The multilayer body according to claim 11, wherein:
the functional layer comprises an adhesive layer stacked on the reformed layer side of the sheet.

13. The multilayer body according to claim 11 , wherein:
the functional layer comprises a hard coat layer stacked on the opposite side of the reformed layer of the sheet.

14. A touch panel, comprising
a first electrode substrate wherein a first transparent conductive film is formed on a first transparent substrate, and
a second electrode substrate wherein a second transparent conductive film is formed on a second transparent substrate so as to face to a first transparent conductive film by leaving a predetermined space;
wherein a movable side electrode substrate of either one of the first transparent substrate or the second transparent substrate comprises the multilayer body according to claim 13.
